(19) United States
(12) Patent Application Publication
(10) Pub. No.: US 2010/0024517 A1
(43) Pub. Date: Feb. 4, 2010

(54) Pressure Gauge

(76) Inventor: Cary Ratner, East Hills, NY (US)

Correspondence Address: Cary Ratner, 38 Overlook Terrace, East Hills, NY, 11577, US

(21) Appl. No.: 12/221,432

(22) Filed: Aug. 4, 2008

(51) Int. Cl. G01L 27/00

(52) U.S. Cl. 73/1.57

(57) ABSTRACT

This invention is a pressure gauge designed to measure pressure over a very wide range of pressures, while maintaining a very high accuracy throughout the range. This invention reduces the number of gauges someone would need to accurately measure pressure over a wide range.

The present invention relates to a pressure gauge for sensing a pressure value, for example, particularly but not exclusively, a pressure value in a fluid.

According to a first aspect of the invention there is provided a pressure gauge for sensing a pressure value comprising a first pressure sensor arranged to be used to provide pressure information in a first pressure range, a second pressure sensor arranged to be used to provide pressure information in a second relatively higher pressure range, a controller arranged to derive the pressure value from the pressure information, wherein the controller is arranged to derive the pressure value from pressure information from only one of the pressure sensors at any given pressure, the gauge comprising an information switch arranged to automatically switch between the pressure sensors at a threshold pressure such that below the threshold pressure, the pressure value is derived from pressure information from the first sensor and above the threshold pressure, the pressure value is derived from pressure information from the second sensor.

Advantageously, the pressure gauge of this invention includes at least two pressure sensors which are arranged to be used across different pressure ranges. Therefore, within a single pressure gauge device it is possible to sense pressure values across a wide range of pressures. Also advantageously, the pressure gauge includes a switch which automatically switches between pressure sensors so that the processor automatically derives the pressure value from a desired pressure sensor—for example the pressure sensor which would normally work best at a particular pressure.

The first pressure sensor is of a type which works better at relatively lower pressures than the second pressure sensor which works better at relatively higher pressures.

Optional features of the invention are specified in the dependent claims, and also in the description. Any of the optional features may be used solely, or in any combination with each other.

Embodiments of the present invention will now be described by way of example only with reference to the accompanying drawings in which:

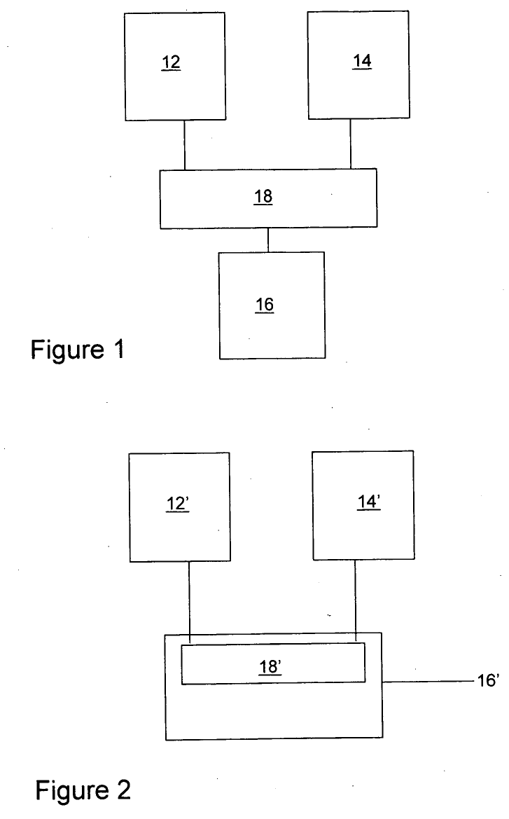

FIG. 1 schematically shows a pressure gauge according to an embodiment of the invention;

FIG. 2 schematically shows a pressure gauge according to a different embodiment of the invention;

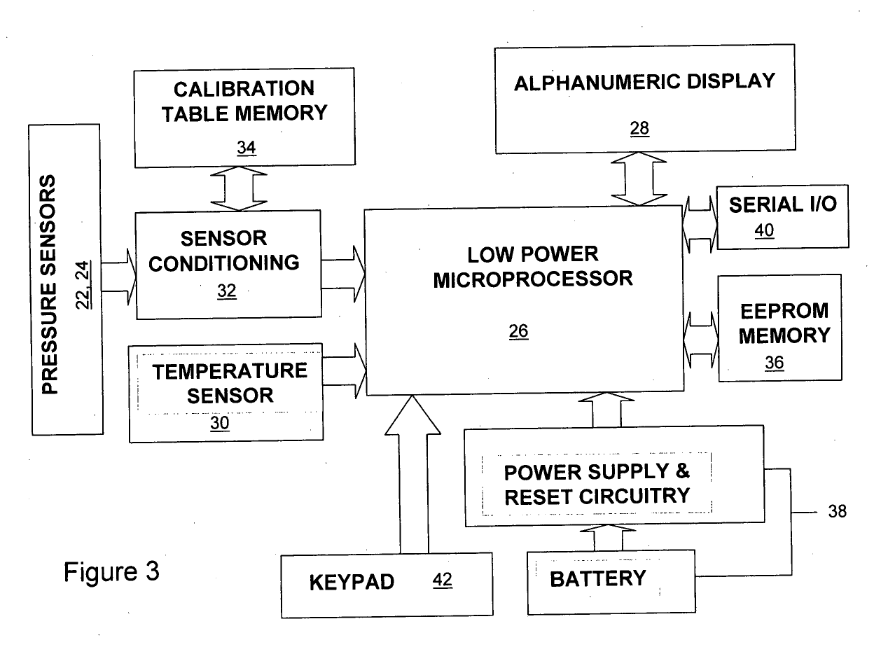

FIG. 3 schematically shows a pressure gauge according to a different embodiment of the invention; and

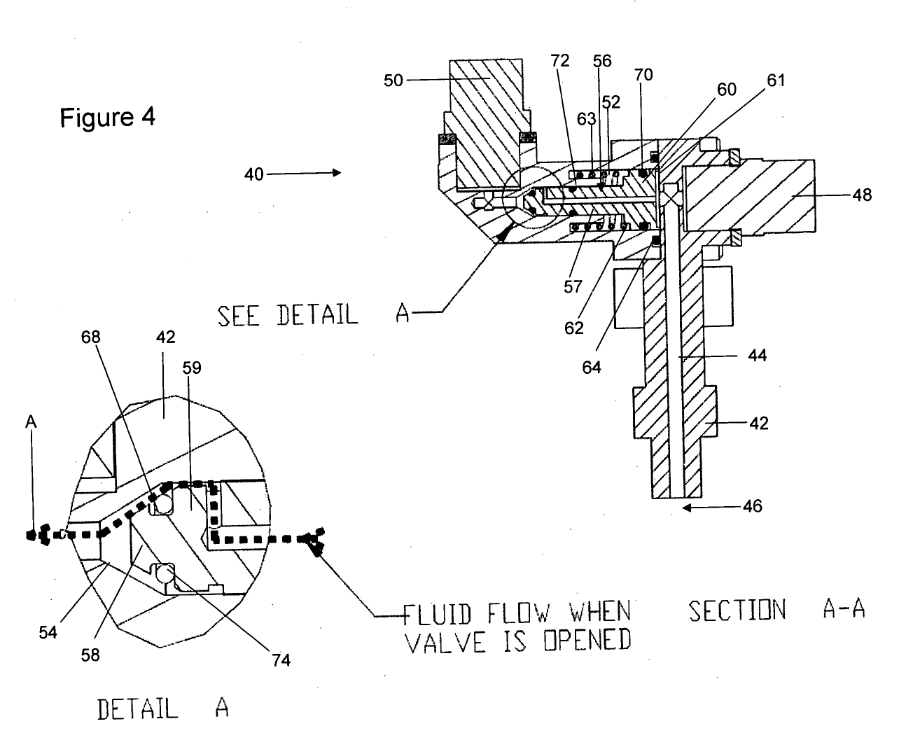

FIG. 4 schematically shows a cross section view through a valve member used with the embodiment of FIG. 3.

Referring to FIG. 1, a pressure gauge 10 for sensing a pressure value, for example in a fluid, is shown. The pressure gauge 10 includes a first pressure sensor 12 and a second pressure sensor 14. The first pressure sensor 12 is arranged to operate across a first pressure range—in this embodiment from 0 to 3 bar (this pressure range may be different in other embodiments), and the second pressure sensor is arranged to operate across a second, relatively higher pressure range—in this embodiment from 0 to 700 bar (this range may be different in other embodiments). For the purposes of this specification, a relatively higher pressure range is intended to mean a range which extends at its upper limit, i.e. at higher pressures, to a pressure which is higher than the highest pressure at which the first pressure sensor is arranged to operate (i.e. in this embodiment, 700 bar is higher than 3 bar). Typically, pressure sensors have an inherent error which is a percentage of the upper limit of their pressure sensing range. So, for example, assuming an error of 0.1% of the upper limit, in this example embodiment, the error in the first pressure sensor would be ±0.003 bar and in the second pressure sensor might be ±0.7 bar.

The first and second pressure sensors 12, 14 provide pressure information relating to the pressure which is being sensed.

The pressure gauge 10 also includes a controller 16 which is arranged to derive the pressure value which is to be sensed from the pressure information provided by the pressure sensors 12, 14. The controller 16 is arranged to derive this pressure information from only one of the pressure sensors 12 or 14 at any one moment, i.e. at any given pressure. It will be apparent to the skilled person that in this embodiment, it will be beneficial for pressure information from the first pressure sensor 12 to be used to determine the pressure value at low pressures (0 to 3 bar) and pressure information on the second pressure sensor 14 to be used to determine the pressure value at relatively higher pressures (above 3 bar) since at low pressures, the ±0.7 bar error associated with the second pressure sensor 14 would be significant.

To this end, the gauge 10 also includes an information switch 18 arranged to automatically switch between the pressure sensors 12, 14 at a threshold pressure (in this embodiment, 3 bar) such that below the threshold pressure, the pressure value is derived from pressure information from the first sensor 12 and above the threshold pressure, the pressure value is derived from pressure information from the second sensor 14. As shown in FIG. 1, the information switch 18 switches the information such that only the information from either the first pressure sensor 12 or the second pressure sensor 14 reaches the controller 16.

In another similar embodiment, as shown in FIG. 2, similar elements of a pressure gauge 10′ are shown with the same reference numerals followed by a ′ symbol. The information switch 18′ is part of the controller 16′—therefore in this embodiment the pressure information from both the first pressure sensor 12′ and the second pressure sensor 14′ reaches the controller 16′, and the information switch is arranged to determine which set of information (either the information from the first sensor 12′ or the second sensor 14′) is subsequently used by the controller 16′ to determine the pressure value.

Advantageously, the pressure gauge of this invention provides accurate, low-error pressure readings across a very wide range of pressures (in this embodiment 0 to 700 bar). This is because more than one sensor is utilised—one which works well at lower pressures and another which is tuned for operation at higher pressures. A user of the pressure gauge is therefore not required to use separate pressure gauges at high and low pressures (above and below the threshold value) as in existing systems. Also the switching at the threshold value between the pressure sensors to be used is automatic. Advantageously, the gauge is configured to automatically select the best, or desired, pressure sensor to be used at a particular pressure. No human operator input is required to make a decision regarding when to switch or to physically perform the switching operation themselves. In some embodiments the switch comprises an electronic switch.

A further embodiment of the invention is shown in FIG. 3. A pressure gauge 20 of this embodiment includes pressure sensors 22, 24, a controller 26, in the form of a low power microprocessor and various optional elements as described in further detail below. The gauge 20 includes an alphanumeric display 28 in communication with the microprocessor 26. The display 28 is arranged to display the pressure value, amongst other things. The display 28 allows convenient viewing of the pressure value being sensed.

The pressure gauge 20 also includes a disconnection means (not shown in FIG. 3). In this embodiment the disconnection means is in the form of a valve (described in further detail below). The disconnection means is arranged to automatically disconnect the first (lower pressure) pressure sensor 22 once the threshold pressure is reached—this is done so that the first pressure sensor 22 is not exposed to the pressure being sensed above this threshold pressure, and thus the first pressure sensor is saved from the risk of damage at high pressures, which it is not configured to withstand in normal use.

Referring to FIG. 4, a valve 40 according to this embodiment comprises a valve body 42 having a fluid channel 44 formed therethrough. In use an end 46 of the fluid channel is arranged to communicate with a fluid whose pressure value is to be sensed. Downstream of the end 46, the fluid channel 44 leads to a high pressure sensor chamber 48, which communicates with the high pressure sensor 24. In this embodiment, the fluid pressure being sensed is experienced by the high pressure sensor chamber 48 at all times—fluid flow to the high pressure sensor chamber 48 is never completely obstructed.

The fluid channel 44 also branches off to lead to a low pressure sensor chamber 50, which communicates with the low pressure sensor 22. As previously described, when the fluid pressure value is increased to a threshold pressure or above, the fluid pressure being sensed is not experienced by the low pressure sensor chamber 50—this is achieved by obstructing the fluid flow to the low pressure sensor chamber 50 at and above the threshold pressure.

The valve body 42 defines a valve chamber 52 including a truncated conical tapered valve seat 54. A valve member 56 is located inside the valve chamber 52. The valve member 56 comprises a generally cylindrical valve portion 57 and a truncated conical valve end 58, which is sized and shaped to correspond to the truncated conical valve seat. The angle of the cone (i.e. of the valve seat and of the valve end) is about 54° in this embodiment. In other embodiments the cone angle may be between 40° and 70°.

Between the cylindrical valve portion 57 and the truncated conical valve end 58, the valve member comprises a reduced diameter cylindrical section 59, which is of a smaller diameter than the cylindrical valve portion 57, and from which the base of the truncated conical valve end 58 extends.

The cylindrical valve portion 57 is arranged to be a close sliding fit within a downstream portion of the valve chamber 52. A valve head 60 is provided at a top (upstream end) of the valve member 56. The valve head 60 defines a shoulder 62 at its downstream side against which a compression spring 63 bears to force the valve member upstream, i.e. to force the valve end 58 out of the valve seat 54.

On its upstream side, the valve head 60 abuts a limiting surface 61 of the valve body 42, which limits the extent of movement of the valve member 56 in the valve's ‘open’ position, i.e. when the low pressure sensor chamber 50 is connected to experience the fluid pressure at the end 46.

The valve member 56 includes three angular channels formed around its circumference. A first annular channel (not labelled) is formed in the valve head 60. A second annular channel (not labelled) 66 is formed in the valve member 56 downstream of the midpoint along the length of the valve member 56. A third annular channel 68 is formed in the conical valve end 58—this channel is formed in the sloped part of the valve end 58, so it has a smaller radius than the second channel, which in turn has a smaller radius than the first channel. Each channel is arranged to receive a correspondingly sized and shaped sealing ring—a first sealing ring 70, a second sealing ring 72 and a third sealing ring 74. Each sealing ring comprises a high density, polyurethane O-ring to provide a seal between the valve member 56 and the valve body 42.

A fourth sealing ring 64 is also provided between the limiting surface 61 of the valve body 42 and the part of the valve body 42 which houses the valve member 56. This sealing ring is of a similar construction to the other sealing rings.

The valve member 56 has a channel 66 formed through it along its central longitudinal axis. The channel 66 is part of the fluid channel 44. The channel 66 extends from the upstream end of the valve head through the cylindrical valve portion 57 before being diverted perpendicularly at an upstream end of the reduced diameter section 59 where it reaches the perimeter of the reduced diameter cylindrical section 59 and communicates with the valve chamber 52.

It will be noted that in this embodiment the fluid channel 44 extends in a first longitudinal direction from its end 46, before splitting at a junction into the high pressure sensor chamber 48, which extends along a longitudinal axis perpendicular to the first longitudinal direction. At this junction the channel 44 also splits in an opposite longitudinal direction along the longitudinal axis of the channel 66 (i.e. also perpendicularly to the first longitudinal direction). The fluid channel 44 is then directed perpendicularly once more to the low pressure sensor chamber 50, whose longitudinal axis runs parallel to the first longitudinal direction.

In use, at low pressure (lower than the threshold pressure), the valve member 56 does not prevent the low pressure sensor chamber 50 from experiencing pressure exerted at the end 46 of the fluid channel 44. The spring acts to force the valve end 58 out of the valve seat 54 such that the fluid channel 44 is not completely obstructed, and the low pressure sensor chamber 50 is thus connected to end 46. This position is shown in FIG. 4. The arrow, A, shows a fluid connection path between the end 46 and the low pressure sensor chamber 50. This is possible due to flow between the reduced diameter cylindrical portion 59 and the valve body 42.

As the pressure value at the end 46 increases, the valve member 56 is forced against the action of the spring (from right to left in the orientation of FIG. 4) such that the truncated conical valve end 58 tightly fits in to the valve seat 54 (the valve end acts as a stopper in a bottle), thus disconnecting the low pressure sensor chamber 50 from the fluid channel 44. The sealing ring 74 provides a secure seal as pressure is increased and provides disconnection at the threshold pressure. The construction and location of the sealing rings facilitate the disconnection.

As the pressure value increases the high pressure sensor camber 48 is still connected and operational.

As the pressure value at the end 46 decreases from high pressure (above the threshold value), when the threshold value is reached, the valve member 56 needs to move to allow reconnection between the fluid channel 44 and the low pressure sensor chamber 50. In practice this is difficult since a low pressure area/vacuum is created downstream of the valve end 58, which is therefore forced to remain in place in the valve seat 54. The feature of the valve end 58 being angled (i.e. the cone angle being about 54° in this embodiment) facilitates reconnection. Ascertaining the correct cone angle is an important advance in itself since it is determined by balancing conflicting requirements of an efficient reconnection and a secure disconnection as previously explained. This is a difficult step which has not been reached in prior systems.

The pressure gauge 20 also comprises a temperature sensor 30. In use, the pressure information from the pressure sensor 22, 24 is temperature dependent. Therefore the temperature sensor 30 is used to calibrate and interpret the pressure information as described in further detail below.

The gauge 20 includes a calibration means, in the form of a sensor conditioning unit 32, and calibration table memory 34. The calibration means is arranged to calibrate the pressure sensors 22, 24. The calibration means is arranged to communicate with the controller 26 as described in further detail below.

The gauge 20 also includes an electrically erasable programmable memory (EEPROM) 36 in communication with the controller 26. The gauge 20 also. includes a power supply and battery 38, as well as a serial input/output unit 40 in communication with the controller 26. A keypad 42 is also provided in communication with the controller 26.

Each of the pressure sensors 22, 24 is part of a bridge circuit (in this embodiment a Wheatstone bridge circuit), and so the pressure information is provided in the form of a differential output voltage which directly relates to the pressure applied to the relevant sensor 22, 24. The output of the bridge sensor is non-linear and is temperature dependent.

Each sensor 22, 24 is connected to the sensor conditioning unit 32 which works in conjunction with the calibration table memory 34. After manufacture of the gauge 20, the gauge 20 has its sensors 22, 24 calibrated. Each sensor 22, 24 is tested at a series of known pressures and temperatures. This is done by presenting the gauge 20 with a number of different calibrated temperature and pressure sources of known, controlled temperatures and pressures. The output voltage of each sensor 22, 24 is measured for specific pressures and temperatures and stored in the form of a calibration table in the calibration table memory 34. The sensor conditioning unit 32 uses these non-linear measurements and compares them to the desired linear relationship which is required by the controller 26. A microprocessor based circuit with EEPROM provides a table of stored correction factors based upon these results. The lookup table is used to program the sensor conditioning unit 32, which acts to correct the non-linear output signal from each pressure sensor (and also to correct temperature and pressure offsets and span errors).

Subsequently the controller 26 is arranged to interpolate real time values when they are being measured between the recalibrated measured points derived from the lookup table. This sensor conditioning and calibration is done according to standard, known processes.

Advantageously, providing a calibration means integral with the gauge 20 allows recalibration as and when required, for example annually.

In operation, during a pressure value reading, the temperature sensor 30 senses the temperature and sends temperature information to the controller 26 so that this can be used in conjunction with the information in the EPROM memory 36 and the calibration table memory 34 in order to arrive at a correct sensed pressure value.

The pressure value is then displayed on the display 28 conveniently visible to a user of the gauge 20.

Various modifications may be made to the present invention without departing from its scope. For example, the gauge may comprise more than two pressure sensors. The sensors may be configured to work across different ranges. For example, the lower pressure sensor may be arranged to work from 0 to 3 bar, whilst the higher pressure sensor is arranged to work from 3 to 700 bar. The threshold may be 3 bar in this case, or it may be less, for example, 2.5 bar. Or, the lower pressure sensor may be arranged to work from 0 to 3 bar, whilst the higher pressure sensor is arranged to work from 2 to 700 bar. The threshold pressure may be 3 bar in this case. Or, the lower pressure sensor may be arranged to work from 0 to 50 bar, whilst the higher pressure sensor is arranged to work from 50 to 80 bar.

The higher pressure sensor may continue to sense across its entire range in some embodiments e.g. from 0 to 700 bar, in an embodiment where the lower pressure sensor is best at 0 to 5 bar. In such an embodiment the pressure value is derived from the lower pressure sensor up until 5 bar, but since the higher pressure sensor is also sensing pressure at these low pressures it can be used in the event of failure of the lower pressure sensor.

1. A pressure gauge for sensing a pressure value comprising a first pressure sensor arranged to be used to provide pressure information in a first pressure range, a second pressure sensor arranged to be used to provide pressure information in a second relatively higher pressure range, a controller arranged to derive the pressure value from the pressure information, wherein the controller is arranged to derive the pressure value from pressure information from only one of the pressure sensors at any given pressure, the gauge comprising an information switch arranged to automatically switch between the pressure sensors at a threshold pressure such that below the threshold pressure, the pressure value is derived from pressure information from the first sensor and above the threshold pressure, the pressure value is derived from pressure information from the second sensor.

2. The pressure gauge of claim 1 comprising a display arranged to display the pressure value.

3. The pressure gauge of claim 1 comprising disconnection means arranged to automatically disconnect the first pressure sensor at the threshold pressure such that the first pressure sensor is not exposed to the pressure being sensed above the threshold pressure.

4. The pressure gauge of claim 3 wherein the disconnection means comprises a valve.

5. The pressure gauge of claim 4 wherein the valve comprises a valve member having an angled valve end arranged to locate within a correspondingly angled valve seat.

6. The pressure gauge of claim 5 wherein the angle of the valve end and valve seat is between 40° and 70°.

7. The pressure gauge of claim 6 wherein the angle is about 54°.

8. The pressure gauge of claim 4 wherein the valve comprises a valve body through which a valve member moves, the valve further comprising one or more high density polyurethane seals provided between the valve member and valve body.

9. The pressure gauge of claim 1 comprising a temperature sensor.

10. The pressure gauge of claim 1 comprising calibration means arranged to calibrate the pressure sensors.

11. The pressure gauge of claim 10 wherein the calibration means comprises calibration table memory arranged to store an updatable lookup table.

12. The pressure gauge of claim 1 comprising a converter arranged to convert the pressure information, which is non-linear, into a desired linear form.

13. The pressure gauge of claim 1 wherein the first pressure range comprises 0 to 3 bars. (1 bar=14.7 psi)

14. The pressure gauge of claim 1 wherein the second pressure range comprises 0 to 700 bars.
